(19) United States
(12) Patent Application Publication
(10) Pub. No.: US 2005/0001552 A1
(43) Pub. Date: Jan. 6, 2005

(54) Cathode-ray tube

(76) Inventor: Osamu Ono, Ibaraki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/867,678

(22) Filed: Jun. 16, 2004

(30) Foreign Application Priority Data
Jun. 17, 2003 (JP) 2003-172369

(51) Int. Cl. H01J 23/08

(52) U.S. Cl. 315/5.34; 315/1

(57) ABSTRACT

An electron beam generating section of an electron gun assembly includes at least a cathode that emits an electron beam, and a control electrode that is disposed on a phosphor screen side of the cathode. The cathode has a cathode face that is opposed to the control electrode, the cathode face having a concave shape with a recessed central portion. The electron beam that is emitted from the cathode face forms a cross-over with a tube axis. A cross-over point of an electron beam, which is emitted from the central portion of the cathode face, differs from a cross-over point of an electron beam, which is emitted from an off-axis portion of the cathode face.

### CROSS-REFERENCE TO RELATED APPLICATIONS

This application is based upon and claims the benefit of priority from prior Japanese Patent Application No. 2003-172369, filed Jun. 17, 2003, the entire contents of which are incorporated herein by reference.

### BACKGROUND OF THE INVENTION

1. Field of the Invention

The present invention relates generally to a cathode-ray tube with an electron gun assembly that emits at least one electron beam, and more particularly to a cathode-ray tube capable of enhancing focus characteristics of an electron beam and drive characteristics, thereby realizing high luminance and high resolution over the entirety of a screen.

2. Description of the Related Art

As is shown in FIG. 8, an in-line electron gun assembly, which is applied to a prior-art color cathode-ray tube, comprises cathodes K having electron emission materials on their faces opposed to a first grid G1; the first grid G1; a second grid G2; a third grid G3; and a fourth grid G4. The cathodes K, first grid G1 and second grid G2 form a triode section (electron beam generating section) that generates electron beams. The third grid G3 and fourth grid G4 form a main lens that accelerates the electron beams and focuses them on a phosphor screen.

In the electron gun assembly, a voltage (drive voltage), which varies in accordance with a video signal, is applied to the cathodes K, thereby varying the amount of each electron beam emitted from the associated cathode K. In this way, the amount of the electron beam that reaches the phosphor screen is controlled. Hence, the amount of light emission from the phosphor screen is controlled, and a desired image is displayed.

FIGS. 9A and 9B are views for explaining the principle of the control of the electron beam amount. FIG. 9A shows an equipotential line of the electron beam generating section in the cut-off state. FIG. 9B shows an equipotential line of the electron beam generating section in the state in which a drive voltage of 30V is applied. The voltage of the first grid G1 is set at 0V, and the cathode application voltage in the cut-off state is set at 100V.

As is shown in FIG. 9A, an electric field permeates from the electron beam passage hole in the first grid G1 to the cathode K. In the cut-off state, the permeating electric field is substantially equal to the cathode potential. Thus, an electron emission region for emitting electrons is not formed on the cathode K. On the other hand, as shown in FIG. 9B, the application of the drive voltage causes imbalance between the permeating electric field and the cathode potential. Consequently, a positive electric field with a maximum point at the center of the cathode is produced at an electron emission region. Electrons are thus emitted from this region. The higher the drive voltage, the greater the electron emission region and the electric field. In short, by varying the magnitude of the drive voltage, the amount of the electron beam emitted from the cathode can be controlled.

However, the electron gun assembly, which controls the electron beam amount by the above scheme, has two potential problems, as described below.

The first problem is due to the fact that the electron emission region varies depending on the magnitude of the drive voltage. As is shown in FIG. 10, an electron beam, which is emitted from the electron emission region, forms a cross-over with a tube axis Z. A beam spot that is formed on the phosphor screen is an image point having a circle of least confusion as an object point. If the electron emission region increases, the circle of least confusion (object point size) thereof also increases. Accordingly, the beam spot size increases. Conversely, if the object point size decreases, the beam spot size also decreases. Hence, if the drive voltage is low, that is, if the electron beam amount (cathode current amount) is small, the beam spot size decreases, and such a problem as the occurrence of moiré arises. When the electron beam amount (cathode current amount) is large, the beam spot size increases, and such a problem as degradation in resolution arises.

The second problem is due to the fact that a current emitted from the cathode has a density distribution, as shown in FIG. 11, since the intensity of the permeating electric field becomes maximum at the center of the cathode. Specifically, the total amount of the electron beam emitted from the cathode (cathode current amount) is expressed by an integration of (area X current density). In the case where the area of the electron emission region is large, the current density at an end part of the electron emission region (i.e. at a location away from the center of the cathode) is low, and a sufficient amount of electrons cannot be produced. To solve this problem, the drive voltage needs to be increased. However, since the cathode-ray tube is generally used at high frequencies, the applicable drive voltage is limited. Hence, there is an increasing demand for the advent of a cathode-ray tube wherein a higher cathode current can be obtained with a low drive voltage.

As has been described above, the prior-art cathode-ray tube has the following two potential problems. The first problem is the occurrence of moiré at a time of low current and the degradation in resolution at a time of high current time, since the beam spot size varies depending on the magnitude of drive voltage. The second problem is that since the electric field intensity at the end part of the electron emission region, which greatly affects the cathode current amount, is small, the cathode is not efficiently used and the cathode current amount cannot be increased.

Jpn. Pat. Appln. KOKAI Publication No. 54-123866, for instance, proposes a structure of an electron gun assembly as means for solving the above problems. This electron gun assembly differs from the above-described electron gun assembly with respect to the structure of the cathode K. As is shown in FIG. 12, the front surface of the cathode, which is opposed to the first grid G1, has a spherical shape and is recessed in a direction away from the first grid G1. With this structure, a large cathode current (electron beam) is obtained with a low drive voltage, and the variation in electron beam spot size due to the magnitude in cathode current can be decreased. The function of this structure is described below in greater detail.

Since the cathode K has the spherical shape, which is recessed in a direction away from the first grid G1, there is substantially no permeating electric field that permeates from the electron beam passage hole in the first grid G1 to the surface of the cathode K. Thus, if a drive current is applied to the cathode K, electrons are emitted from the entire surface of the cathode K, regardless of the magnitude of the drive current, as shown in FIG. 13. In addition, since the cathode has the spherical shape, the electron beam theoretically forms a cross-over at one point. Therefore, the problems in the prior art, such as the occurrence of moiré or degradation in resolution due to the variation in the electron emission region, are solved.

As regards the cathode current density distribution, the current density is slightly higher at an end part than at a central part. Unlike the prior-art electron gun assembly, the cathode current emitted from the cathode K can be increased.

In theory, with the electron gun assembly using the cathode with the recessed spherical shape, the electron beam forms a cross-over at one point. However, this holds true only when the cathode current is small (at a time of low current). The reason is that in actual cases, if the current has a certain value or more, a repulsion effect due to space charge becomes unignorable. In particular, at a time of high luminance (high current), this effect becomes more conspicuous and the object point size cannot sufficiently be improved. Moreover, a similar space charge repulsion effect occurs between the main lens section and the phosphor screen. This results in a considerable degradation in electron beam size at a time of high current. To increase the divergence angle of an electron beam, which is emitted from the electron beam generating section, is one method to solve this problem. In this case, however, there arises an adverse effect due to a spherical aberration of the main lens section.

In consideration of the space charge repulsion effect occurring between the main lens section and the phosphor screen and at the region of the cross-over, the above-described electron gun assembly can hardly improve the resolution at the time of high luminance display. Rather, in some cases, the resolution may deteriorate.

### BRIEF SUMMARY OF THE INVENTION

The present invention has been made in consideration of the above-described problems, and its object is to provide a cathode-ray tube with high display quality.

According to a first aspect of the present invention, there is provided a cathode-ray tube comprising an electron gun assembly including an electron beam generating section that generates an electron beam and a main lens section that focuses the electron beam generated from the electron beam generating section onto a phosphor screen, wherein the electron beam generating section includes at least a cathode that emits an electron beam, and a control electrode that is disposed on the phosphor screen side of the cathode, the cathode has a cathode face that is opposed to the control electrode, the cathode face having a concave shape with a recessed central portion, and the electron beam that is emitted from the cathode face forms a cross-over with a tube axis, and a cross-over point of an electron beam, which is emitted from the central portion of the cathode face, differs from a cross-over point of an electron beam, which is emitted from an off-axis portion of the cathode face.

According to a second aspect of the present invention, there is provided a cathode-ray tube comprising an electron gun assembly including an electron beam generating section that generates an electron beam and a main lens section that focuses the electron beam generated from the electron beam generating section onto a phosphor screen, wherein the electron beam generating section includes at least a cathode that emits an electron beam, and a control electrode that is disposed on the phosphor screen side of the cathode, the cathode has a cathode face that is opposed to the control electrode, the cathode face having a concave shape with a recessed central portion such that the electron beam that is emitted from the cathode face forms a cross-over with a tube axis, and the cathode face has a smaller curvature at an off-axis portion thereof than the central portion thereof.

According to a third aspect of the present invention, there is provided a cathode-ray tube comprising an electron gun assembly including an electron beam generating section that generates an electron beam and a main lens section that focuses the electron beam generated from the electron beam generating section onto a phosphor screen, wherein the electron beam generating section includes at least a cathode that emits an electron beam, and a control electrode that is disposed on the phosphor screen side of the cathode, the cathode has a cathode face that is opposed to the control electrode, the cathode face having an aspherical concave shape with a recessed central portion, and the electron beam that is emitted from the cathode face forms a cross-over with a tube axis, and a cross-over point of an electron beam, which is emitted from the central portion of the cathode face, is closer to the cathode than a cross-over point of an electron beam, which is emitted from an off-axis portion of the cathode face.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a horizontal cross-sectional view that schematically shows the structure of a color cathode-ray tube apparatus according to an embodiment of the present invention;

FIG. 2 is a horizontal cross-sectional view that schematically shows the structure of an electron gun assembly that is applicable to the cathode-ray tube apparatus shown in FIG. 1;

FIG. 3 is a cross-sectional view that schematically shows the structure of a cathode that is applicable to the electron gun assembly shown in FIG. 2;

FIG. 4 is a graph illustrating an example of a current density distribution in the electron gun assembly using the cathode shown in FIG. 3;

FIG. 5 shows the trajectory of an electron beam that is emitted from the cathode shown in FIG. 3;

FIG. 6 is a cross-sectional view that schematically shows the structure of another cathode, which is applicable to the electron gun assembly shown in FIG. 2;

FIG. 7 is a horizontal cross-sectional view that schematically shows the structure of another electron gun assembly that is applicable to the cathode-ray tube apparatus shown in FIG. 1;

FIG. 8 is a horizontal cross-sectional view that schematically shows the structure of a prior-art electron gun assembly;

FIG. 9A is a view for explaining a cut-off state in the prior-art electron gun assembly;

FIG. 9B is a view for explaining a case where a drive voltage is applied to the prior-art electron gun assembly;

FIG. 10 shows the trajectory of an electron beam that is emitted from the cathode of the electron gun assembly shown in FIG. 8;

FIG. 11 shows an example of a current density distribution of the prior-art cathode;

FIG. 12 is a cross-sectional view that schematically shows the structure of a prior-art cathode;

FIG. 13 shows the trajectory of an electron beam emitted from the cathode shown in FIG. 12; and

FIG. 14 is a cross-sectional view that schematically shows the structure of another cathode, which is applicable to the electron gun assembly shown in FIG. 2.

### DETAILED DESCRIPTION OF THE INVENTION

A cathode-ray tube according to an embodiment of the present invention will now be described with reference to the accompanying drawings.

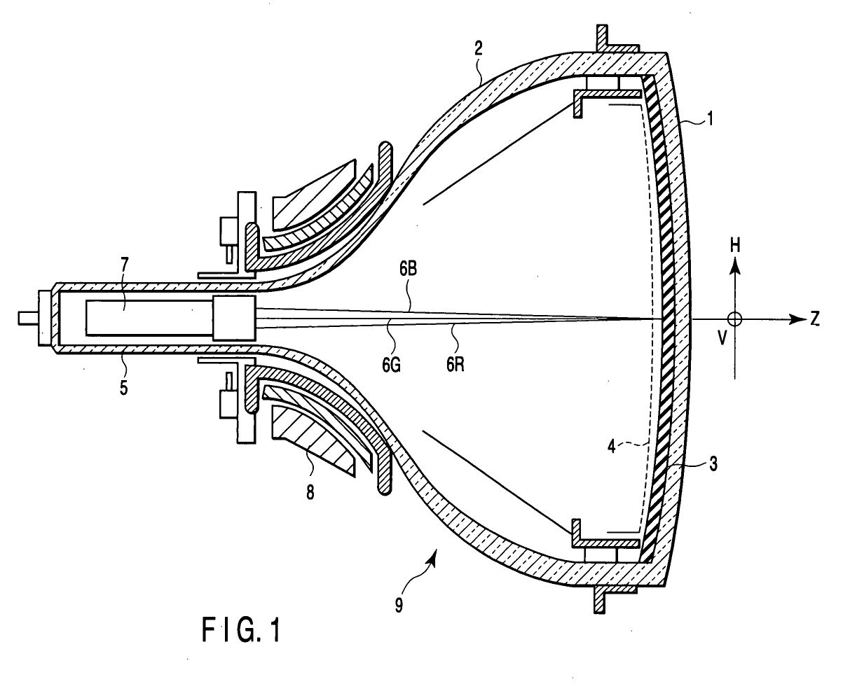

As is shown in FIG. 1, a cathode-ray tube apparatus, that is, a self-convergence type in-line color cathode-ray tube apparatus, has a vacuum envelope 9. The vacuum envelope 9 includes a panel 1 and a funnel 2 integrally coupled to the panel 1. A phosphor screen 3 is disposed on an inside surface of the panel 1. The phosphor screen 3 has three-color striped or dot-shaped phosphor layers, which emit blue, green and red light. A shadow mask 4 is disposed to face the phosphor screen 3. The shadow mask 4 has many apertures in its inside part.

An in-line electron gun assembly 7 is disposed within a cylindrical neck 5, which corresponds to a small-diameter portion of the funnel 2. The electron gun assembly 7 emits three in-line electron beams 6B, 6G and 6R (i.e. a center beam 6G and side beams 6B and 6R) which are arranged in line and travel in the same horizontal plane. A deflection yoke 8 is disposed to extend from a large-diameter portion of the funnel 2 to the neck 5. The deflection yoke 8 generates non-uniform deflection magnetic fields for deflecting the three electron beams 6B, 6G and 6R, which have been emitted from the electron gun assembly 7, in a horizontal direction H and a vertical direction V. The non-uniform deflection magnetic fields comprise a pincushion-shaped horizontal deflection magnetic field and a barrel-shaped vertical deflection magnetic field.

The three electron beams 6B, 6G and 6R emitted from the electron gun assembly 7 are self-converged toward the phosphor screen 3 and focused on the associated color phosphor layers on the phosphor screen 3. The three electron beams 6B, 6G and 6R are deflected by the non-uniform deflection magnetic fields generated by the deflection yoke 8 and scanned over the phosphor screen 3 through the shadow mask 4 in the horizontal direction H and vertical direction V. Thus, a color image is displayed.

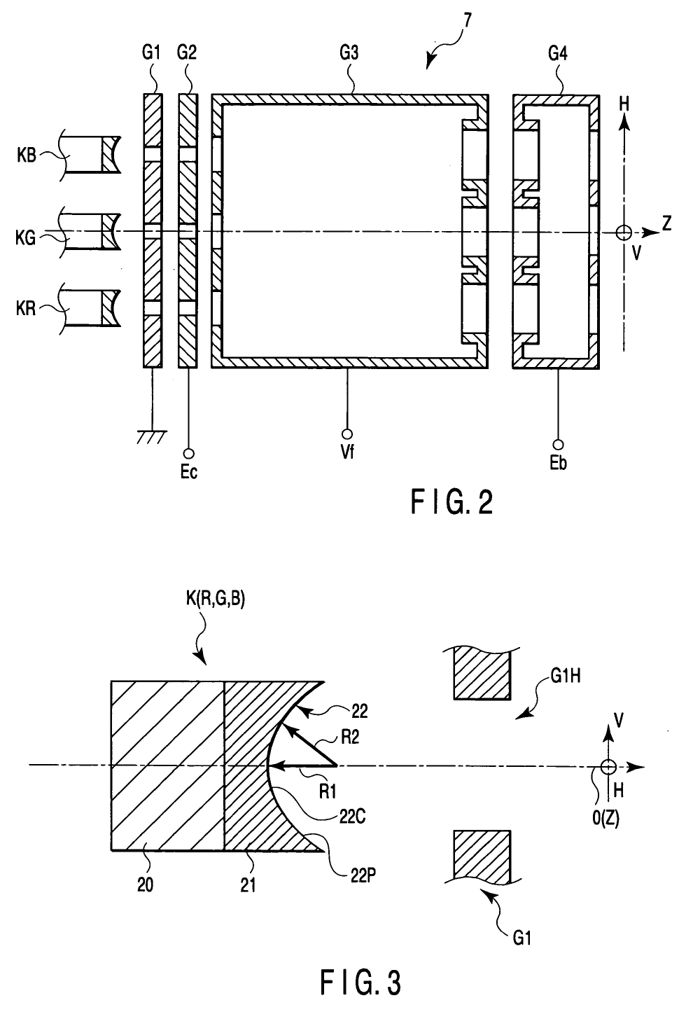

As is shown in FIG. 2, the electron gun assembly 7 includes three cathodes K (R, G, B) arranged in line in the horizontal direction H, three heaters that individually heat the cathodes K (R, G, B), and a plurality of electrodes. The plural electrodes, that is, a first grid (control grid) G1, a second grid G2, a third grid (focus electrode) G3 and a fourth grid (anode electrode) G4, are successively arranged from the cathode K (R, G, B) side toward the phosphor screen in a tube axis direction Z. The cathodes K (R, G, B) and the four electrodes are integrally supported and fixed by a pair of insulation support members.

Each of the four grids has three electron beam passage holes with predetermined sizes, which are arranged in the horizontal direction H. The first grid G1 and second grid G2 are formed of thin plate electrodes. Each of the plate electrodes has, in its plate face, three electron beam passage holes that are arranged in line in the horizontal direction H in association with the three cathodes K (R, G, B). Each of the three electron beam passage holes has a small-diameter circular shape.

Each of the third grid G3 and fourth grid G4 comprises integrally formed cylindrical electrodes. Specifically, these cylindrical electrodes are cup-shaped electrodes, whose open ends are abutted on each other. The third grid G3 has, in its surface opposed to the second grid G2, three electron beam passage holes that are arranged in line in the horizontal direction H in association with the three cathodes K (R, G, B). Each of these three electron beam passage holes has a circular shape with a slightly greater diameter than the diameter of each of the electron beam passage holes formed in the second grid G2. In addition, the third grid G3 has, in its surface opposed to the fourth grid G4, three electron beam passage holes that are arranged in line in the horizontal direction H in association with the three cathodes K (R, G, B). Each of these three electron beam passage holes has a large-diameter circular shape.

The fourth grid G4 has, in each of its surfaces opposed to the third grid G3 and the phosphor screen, three electron beam passage holes that are arranged in line in the horizontal direction H in association with the three cathodes K (R, G, B). Each of these three electron beam passage holes has a large-diameter circular shape.

As is shown in FIG. 3, the cathode K (R, G, B) includes a cylindrical support member 20, whose distal end is provided with an electron beam emission section 21 that emits an electron beam. The electron beam emission section 21 has a cathode face 22, which is opposed to the first grid G1 and emits an electron beam. At least a surface of the electron beam emission section 21, which is opposed to the first grid G1, is formed of an electron emission material. In addition, the cathode face 22 has a concave shape with a central portion 22C, which is recessed in a direction away from the first grid G1.

The cathode face 22 has an aspherical shape having different curvatures at its central portion 22C and its off-axis portion 22P. The central portion 22C is a circular region centering on a center axis O of a circular electron beam passage hole G1H formed in the first grid G1. The off-axis portion 22P is an annular region that is away from the center axis O and surrounds the central portion 22C. The center axis O is parallel to the tube axis Z. As regards the cathode K that emits a center beam 6G, the center axis O substantially coincides with the tube axis Z.

In other words, the cathode face 22 has an aspherical shape that is defined by combining a plurality of curvatures. The curvature of the off-axis portion 22P is less than that of the central portion 22C. Specifically, if the curvature of the central portion 22C is R1 and the curvature of the off-axis portion 22P is R2, the cathode face 22 is formed to meet the relationship, R1>R2.

For the purpose of simplicity, the cathode face 22 is divided into two regions in this embodiment. Alternatively, the cathode face 22 may be divided into three or more regions. Needless to say, it is desirable that the cathode face 22 be formed to have a gradually decreasing curvature from the center axis O toward the peripheral region, that is, the cathode face 22 be formed to have a smooth aspherical shape. In this case, too, it should suffice if the cathode face 22 meets the relationship, R1>R2, when the curvature of the on-axis portion centering on the center axis O is compared with the off-axis portion that is away from the central axis O.

In the electron gun assembly 7 with the above-described structure, a modulation signal (drive voltage), which is obtained by superimposing a video signal on a DC voltage of about 0 to 10V, is applied to the cathode K (R, G, B). The first grid G1 is grounded. The second grid G2 is supplied with a DC voltage Ec of about 300 to 1000V. A fixed focus voltage Vf of about 6 to 10 kV is applied to the third grid G3. An anode voltage Eb of about 20 to 35 kV is applied to the fourth grid G4.

In the electron gun assembly 7, the above-mentioned voltages are applied to the respective grids, thereby constituting an electron beam generating section, a prefocus lens section, and a main lens section. To be more specific, the electron beam generating section is formed by the cathodes K, first grid G1 and second grid G2. The electron beam generating section generates electron beams and forms a cross-over of each electron beam.

The prefocus lens section is formed by the second grid G2 and third grid G3. The prefocus lens section accelerates and prefocuses electron beams that are generated from the electron beam generating section. The main lens section is formed by the third grid G3 and fourth grid G4. The main lens section accelerates the electron beams, which are prefocused by the prefocus lens section, and ultimately focuses them on the phosphor screen.

According to the electron gun assembly 7 with the above-described structure, a large cathode current (electron beam amount) can be obtained with a low drive voltage, and a variation in beam spot size on the phosphor screen, which is due to a variation in cathode current, can be reduced. In particular, a beam spot size at a time of high luminance (i.e. at a time of large cathode current) can be reduced. The operation relating to these features will be described below in detail.

The cathode K has the cathode face 22 that is recessed in a direction away from the first grid G1. Thus, an electric field hardly permeates from the electron beam passage hole G1H in the first grid G1 to the cathode face 22. Therefore, if a drive voltage is applied to the cathode K, an electron beam is emitted from the entirety of the cathode face 22, regardless of the magnitude of the drive voltage.

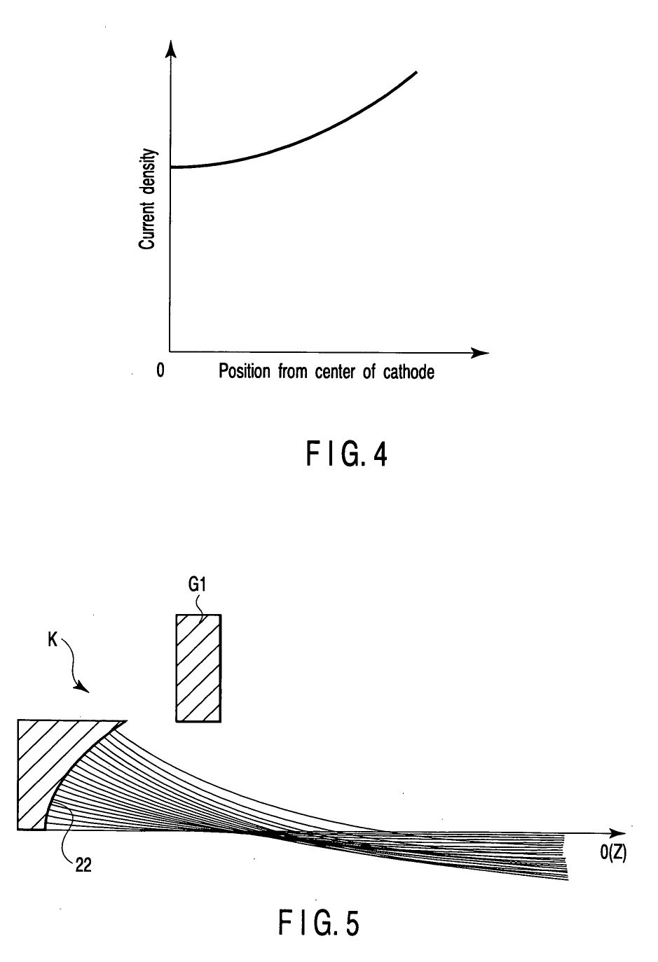

The electron gun assembly 7 has a cathode current density distribution, as shown in FIG. 4, which indicates a slightly higher current density at the off-axis portion than at the central portion (near center axis O). The cathode current amount is expressed by an integration of (the area of cathode face contributing to electron emission) X (current density). By using the cathode K with the distribution shown in FIG. 4, the cathode current that is emitted from the cathode face 22 can be increased. Even with a low drive voltage, a large cathode current (electron beam amount) can be obtained. Moreover, even if the magnitude of cathode current varies, a variation in beam spot size on the phosphor screen can be reduced.

Next, a description is given of the size of the beam spot that is formed by the electron beam reaching the phosphor screen 3. The cathode face 22 of cathode K, which has the recessed central portion 22C, emits the electron beam, and the emitted electron beam forms a cross-over with the center axis O (or tube axis Z). The cross-over, however, does not concentrate on one point on the center axis O (or tube axis Z).

To be more specific, as shown in FIG. 5, a cross-over point of an electron beam, which is emitted from the central portion 22C of the cathode face 22, differs from a cross-over point of an electron beam, which is emitted from the off-axis portion 22P of the cathode face 22. Accordingly, the space charge repulsion effect, which occurs due to concentration of the cross-over at one point, is alleviated and the object point size for the main lens section can be reduced.

The difference in position of cross-over results from the aspherical shape of the cathode face 22. In this embodiment, the curvature of the off-axis portion 22P of cathode face 22 is made less than that of the central portion 22C. Accordingly, the cross-over point of the electron beam emitted from the central portion 22C is located closer to the cathode K side than the cross-over point of the electron beam emitted from the off-axis portion 22P (in other words, the electron beam forms a cross-over at a position closer to the phosphor screen, as the point of emission of the electron beam goes away from the center of the cathode face 22).

By virtue of this feature, the object point distance for the main lens section decreases as the point of emission of the electron beam goes away from the center axis O, and a spherical aberration due to the main lens section can be canceled. Even if the divergence angle of the electron beam is increased to some degree, a spherical aberration hardly occurs in the main lens section.

As stated above, the effect due to the object point size and spherical aberration can be suppressed, and the divergence angle of the electron beam can be increased. Thus, the space charge repulsion effect between the main lens section and phosphor screen 3 can be reduced, and the beam spot size at the time of high luminance can remarkably be reduced.

According to the cathode-ray tube of the present embodiment, as described above, a large cathode current can be obtained with a low drive voltage. It is thus possible to make the cathode-ray tube, which is used with high frequencies, adaptable to the environment of use in which the applicable drive voltage is limited. Furthermore, according to this cathode-ray tube, the variation in beam spot size due to a variation in cathode current can be suppressed. It is thus possible to prevent occurrence of moiré due to an excessively small beam spot size at the time of small cathode current, and to prevent degradation in resolution due to an excessively large beam spot size at the time of large cathode current. According to this cathode-ray tube, a cross-over point of an electron beam, which is emitted from the central portion of the cathode face, differs from a cross-over point of an electron beam, which is emitted from the off-axis portion of the cathode face. The cross-over does not concentrate on one point. Accordingly, the space charge repulsion effect is alleviated and the object point size for the main lens section can be reduced. Besides, according to this cathode-ray tube, the cross-over point of the electron beam emitted from the central portion of the cathode face is located closer to the cathode side than the cross-over point of the electron beam emitted from the off-axis portion. By virtue of this feature, the object point distance for the main lens section decreases as the point of emission of the electron beam goes away from the center axis, and a spherical aberration due to the main lens section can be canceled. Hence, the effect due to the object point size and spherical aberration can be suppressed, and the divergence angle of the electron beam can be increased. Therefore, the beam spot size at the time of high luminance can remarkably be reduced, and a cathode-ray tube with high contrast, high luminance and high resolution can be provided.

Another embodiment of the invention will now be described.

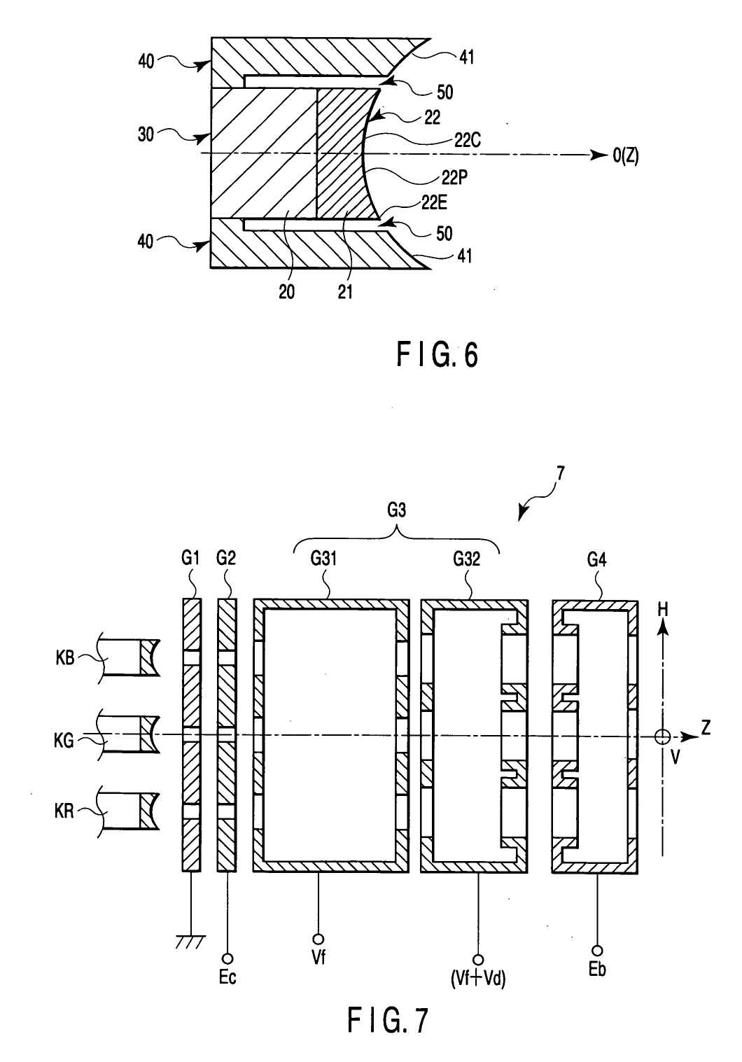

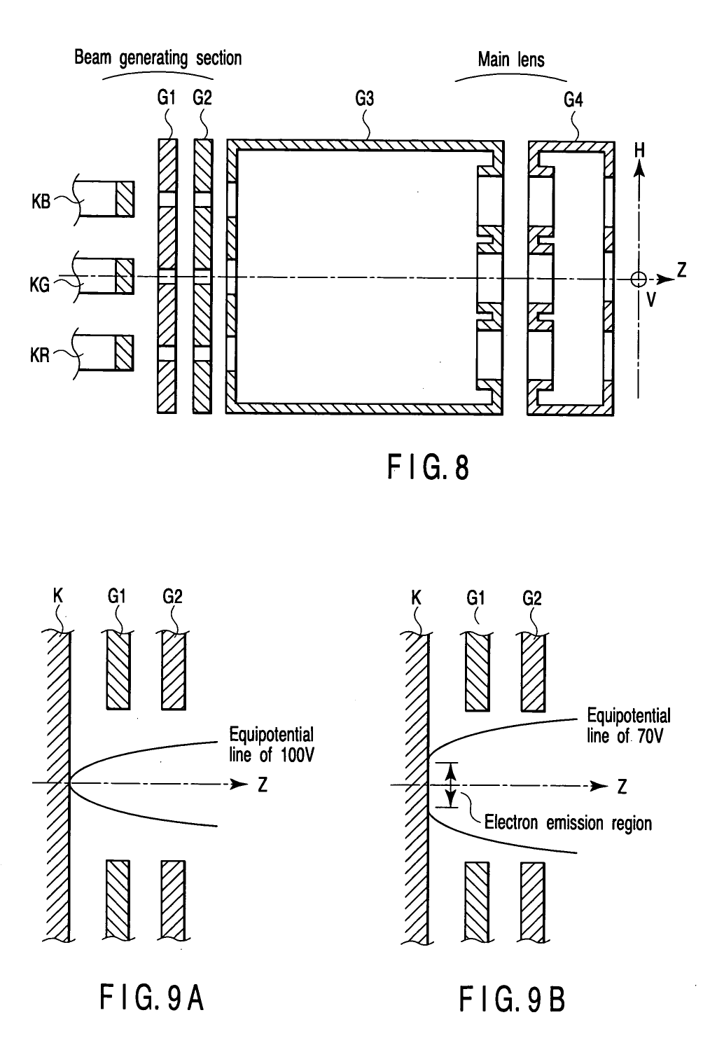

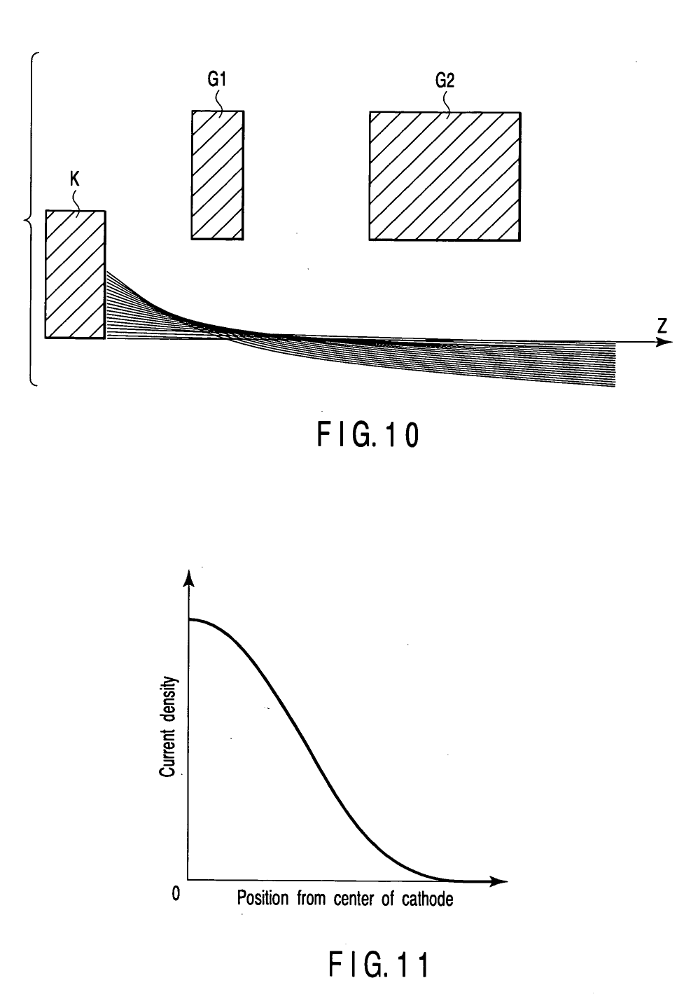

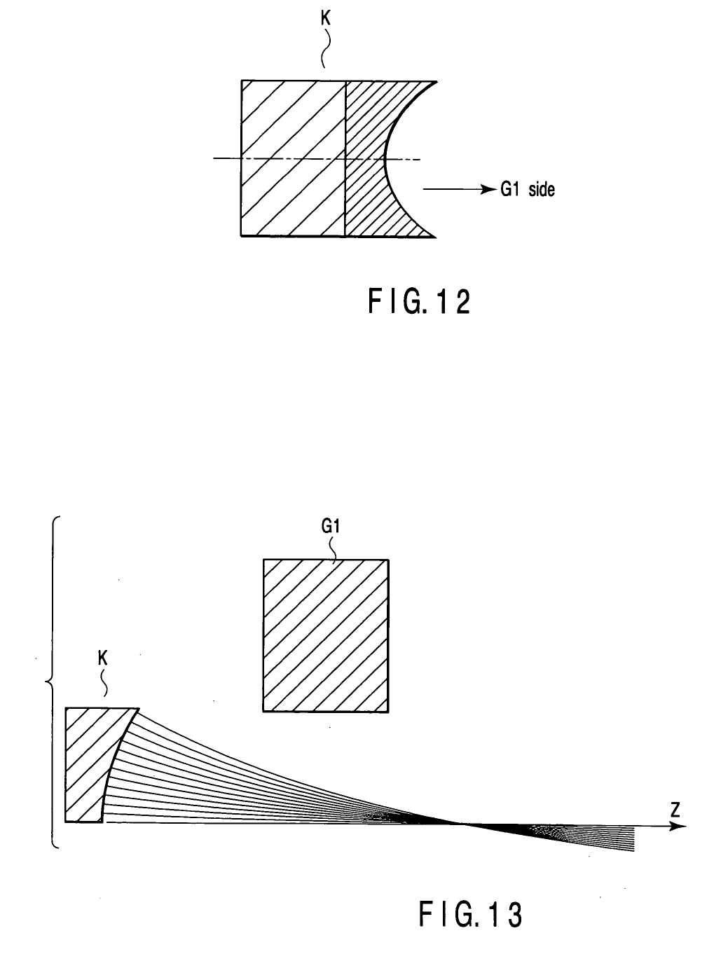

As is shown in FIG. 6, a cathode K comprises a cathode body 30 and an auxiliary member 40. The cathode body 30 includes a cylindrical support member 20, whose distal end is provided with an electron beam emission section 21 that emits an electron beam. The electron beam emission section 21 has a cathode face 22, which is opposed to the first grid G1 and emits an electron beam. At least a surface of the electron beam emission section 21, which is opposed to the first grid G1, is formed of an electron emission material. In addition, the cathode face 22 has a concave central portion 22C, which is recessed in a direction away from the first grid G1.

The cathode face 22 has an aspherical shape having different curvatures at its central portion 22C and off-axis portion 22P. That is, the cathode face 22 has an aspherical shape with a combination of a plurality of curvatures. The off-axis portion 22P has a less curvature than the central portion 22C.

The auxiliary member 40 is disposed in a peripheral region of the cathode face 22 of cathode body 30, that is, in a region more away from the center axis than the cathode body 30. The auxiliary member 40 controls the trajectory of the electron beam that is emitted from the off-axis portion 22P of the cathode face 22. Specifically, at least a surface 41 of the auxiliary member 40, which is opposed to the first grid G1, is formed of a material that emits no electron beam (or emits an electron beam less easily than the cathode face does). The surface 41 of the auxiliary member 40 has a concave shape, which is recessed, for example, in a direction away from the first grid G1. It is desirable that the auxiliary member 40 be disposed annularly around a peripheral portion 22E of the cathode face 22.

According to the cathode K with the above-described structure, the auxiliary member 40 can prevent a disturbance in electric field due to concentration of electric field on the peripheral portion 22E of cathode face 22. Accordingly, the electron beam that is emitted from the peripheral portion 22E of cathode face 22 can be focused (converged) on the center axis O with a proper trajectory (i.e. the cross-over can be formed at a proper position on the center axis).

The cathode K has a groove portion 50 that separates the cathode body 30 and auxiliary member 40. With this structure, it becomes possible to prevent migration of a metal substance, e.g. barium, from the cathode body 30 into the auxiliary member 40, such migration occurring in the case of an impregnation-type cathode. Generation of an undesired electron beam can thus be prevented. According to the cathode of this embodiment, generation of an undesired electron beam can be prevented and the electron beam can be focused with a proper trajectory. Therefore, a cathode-ray tube with a higher quality can be provided.

With respect to each of the above-described embodiments, dynamic compensation of deflection aberration has not been discussed. In order to further improve the resolution, the electron gun assembly may include at least one quadrupole lens that has different electron beam focusing functions in the horizontal direction H and vertical direction V.

Specifically, as shown in FIG. 7, the main lens section is formed by a first segment G31 and a second segment G32 of the third grid G3, and the fourth grid G4. The first segment G31 is supplied with a predetermined DC voltage Vf. The second segment G32 is supplied with a dynamic focus voltage (Vf+Vd) that is obtained by superimposing a parabolically varying AC voltage component Vd on a predetermined DC voltage Vf. This dynamic focus voltage (Vf+Vd) varies in synchronism with a saw-tooth deflection current in a parabolic fashion in accordance with a variation in deflection amount of electron beams. The fourth grid G4 is supplied with an anode voltage Eb. A quadrupole lens is created between the first segment G31 and second segment G32. The quadrupole lens can dynamically compensate a deflection aberration, and a beam spot with less deformation can be formed over the entire phosphor screen.

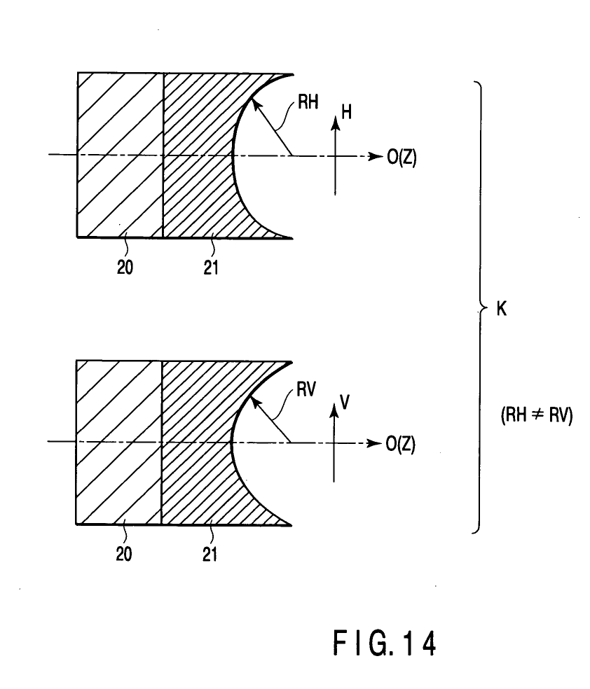

With respect to each of the above-described embodiments, the axial symmetry of curvature of the cathode face of the cathode (symmetry in the horizontal direction H and vertical direction V) has not been discussed. The cathode face may be formed to have symmetric curvature in one of the axes, or to have symmetric curvature in both axes (i.e. the curvature in the horizontal direction H is equal to that in the vertical direction V). In addition, as shown in FIG. 14, the cathode face may be formed to have a curvature RH in the horizontal direction H and a curvature RV in the vertical direction V, which are different from each other. In short, the curvature of the cathode face in each direction may be freely chosen in accordance with the size and type of the cathode-ray tube and the mode of the main lens system.

Each of the above-described embodiments is directed to the in-line color cathode-ray tube. However, since the above-described electron gun assembly is configured to independently generate three electron beams, this invention is applicable to a cathode-ray tube with a delta electron gun assembly. Furthermore, this invention is applicable to other types of cathode-ray tubes, such as a black-and-white cathode-ray tube that emits a single electron beam.

As has been described above, according to the cathode-ray tube of the embodiment, the electron gun assembly includes at least a cathode for emitting an electron beam, and a control electrode, i.e. a first grid, which is disposed on the phosphor screen side of the cathode. The cathode face of the cathode, which is opposed to the control electrode, has a concave shape with a recessed central portion. The curvature of the off-axis portion of the cathode face is less than that of the central portion of the cathode face.

The cathode face has the concave shape, which is recessed in a direction away from the first grid. Thus, an electric field hardly permeates from the electron beam passage hole in the first grid to the cathode face. Therefore, if a drive voltage is applied to the cathode, an electron beam is emitted from the entirety of the cathode face, regardless of the magnitude of the drive voltage. Accordingly, the cathode current density distribution indicates a slightly higher current density at the off-axis portion than at the central portion. Since the cathode current amount is expressed by an integration of (area X current density), the cathode current that is emitted from the cathode can be increased. Even with a low drive voltage, a large cathode current can be obtained.

Since the cathode face has the aspherical shape, the cross-over of the electron beam emitted from the cathode face does not concentrate on one point. Accordingly, the space charge repulsion effect, which occurs in the prior art, is remarkably suppressed and the object point size can be reduced.

Since the curvature of the off-axis portion of the cathode face is made less than that of the central portion of the cathode face, the cross-over point of the electron beam emitted from the central portion is located closer to the cathode side than the cross-over point of the electron beam emitted from the off-axis portion. By virtue of this feature, the object point distance for the main lens section decreases as the point of emission of the electron beam goes away from the center axis, and a spherical aberration due to the main lens section can be canceled. Even if the divergence angle of the electron beam is increased to some degree, a spherical aberration hardly occurs in the main lens section. Hence, the object point size and spherical aberration can be decreased, and the divergence angle of the electron beam can be increased. Therefore, the space charge repulsion effect between the main lens section and phosphor screen can be reduced, and the beam spot size at the time of high luminance can remarkably be reduced. As a result, a large cathode current can be obtained with a low drive voltage, and a variation in beam spot size due to the magnitude of cathode current can be reduced. It is thus possible to realize high contrast (high luminance) and high resolution with no moiré.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A cathode-ray tube comprising an electron gun assembly including an electron beam generating section that generates an electron beam and a main lens section that focuses the electron beam generated from the electron beam generating section onto a phosphor screen,
wherein the electron beam generating section includes at least a cathode that emits an electron beam, and a control electrode that is disposed on the phosphor screen side of the cathode,
the cathode has a cathode face that is opposed to the control electrode, the cathode face having a concave shape with a recessed central portion, and
the electron beam that is emitted from the cathode face forms a cross-over with a tube axis, and a cross-over point of an electron beam, which is emitted from the central portion of the cathode face, differs from a cross-over point of an electron beam, which is emitted from an off-axis portion of the cathode face.

2. The cathode-ray tube according to claim 1, wherein the cathode includes a cathode body with a cathode face that emits an electron beam, and an auxiliary member that is disposed in a peripheral region of the cathode face and controls a trajectory of the electron beam that is emitted from the off-axis portion of the cathode face.

3. The cathode-ray tube according to claim 2, wherein the cathode includes a groove portion that separates the cathode body and the auxiliary member.

4. The cathode-ray tube according to claim 1, wherein the cathode face has a curvature in a horizontal direction and a curvature in a vertical direction, which are different from each other.

5. The cathode-ray tube according to claim 1, wherein the electron gun assembly includes at least one quadrupole lens that has different electron beam focusing functions in a horizontal direction and a vertical direction.

6. A cathode-ray tube comprising an electron gun assembly including an electron beam generating section that generates an electron beam and a main lens section that focuses the electron beam generated from the electron beam generating section onto a phosphor screen,
wherein the electron beam generating section includes at least a cathode that emits an electron beam, and a control electrode that is disposed on the phosphor screen side of the cathode,
the cathode has a cathode face that is opposed to the control electrode, the cathode face having a concave shape with a recessed central portion such that the electron beam that is emitted from the cathode face forms a cross-over with a tube axis, and
the cathode face has a smaller curvature at an off-axis portion thereof than the central portion thereof.

7. The cathode-ray tube according to claim 6, wherein the cathode includes a cathode body with a cathode face that emits an electron beam, and an auxiliary member that is disposed in a peripheral region of the cathode face and controls a trajectory of the electron beam that is emitted from the off-axis portion of the cathode face.

8. The cathode-ray tube according to claim 7, wherein the cathode includes a groove portion that separates the cathode body and the auxiliary member.

9. The cathode-ray tube according to claim 6, wherein the cathode face has a curvature in a horizontal direction and a curvature in a vertical direction, which are different from each other.

10. The cathode-ray tube according to claim 6, wherein the electron gun assembly includes at least one quadrupole lens that has different electron beam focusing functions in a horizontal direction and a vertical direction.

11. A cathode-ray tube comprising an electron gun assembly including an electron beam generating section that generates an electron beam and a main lens section that focuses the electron beam generated from the electron beam generating section onto a phosphor screen,
wherein the electron beam generating section includes at least a cathode that emits an electron beam, and a control electrode that is disposed on the phosphor screen side of the cathode,
the cathode has a cathode face that is opposed to the control electrode, the cathode face having an aspherical concave shape with a recessed central portion, and
the electron beam that is emitted from the cathode face forms a cross-over with a tube axis, and a cross-over point of an electron beam, which is emitted from the central portion of the cathode face, is closer to the cathode than a cross-over point of an electron beam, which is emitted from an off-axis portion of the cathode face.

12. The cathode-ray tube according to claim 11, wherein the cathode includes a cathode body with a cathode face that emits an electron beam, and an auxiliary member that is disposed in a peripheral region of the cathode face and controls a trajectory of the electron beam that is emitted from the off-axis portion of the cathode face.

13. The cathode-ray tube according to claim 12, wherein the cathode includes a groove portion that separates the cathode body and the auxiliary member.

14. The cathode-ray tube according to claim 11, wherein the cathode face has a curvature in a horizontal direction and a curvature in a vertical direction, which are different from each other.

15. The cathode-ray tube according to claim 11, wherein the electron gun assembly includes at least one quadrupole lens that has different electron beam focusing functions in a horizontal direction and a vertical direction.
